(19) United States
(12) Patent Application Publication
(10) Pub. No.: US 2026/0048564 A1
(43) Pub. Date: Feb. 19, 2026

(54) DUNNAGE CONVERTER OUTPUT CHUTE SAFETY MECHANISM

(71) Applicant: Intertape Polymer Corp., Sarasota, FL (US)

(72) Inventor: Raimond Demers, Sarasota, FL (US)

(73) Assignee: Intertape Polymer Corp., Sarasota, FL (US)

(21) Appl. No.: 19/368,698

(22) Filed: Oct. 24, 2025

Related U.S. Application Data
(63) Continuation of application No. 18/467,056, filed on Sep. 14, 2023, now abandoned.
(60) Provisional application No. 63/407,382, filed on Sep. 16, 2022.

(51) Int. Cl. B31D 5/00

(52) U.S. Cl. CPC B31D 5/0047; B31D 2205/0058; B31D 2205/007; B31D 2205/0082; B31D 2205/0094

(57) ABSTRACT

An output chute safety mechanism includes an output chute, an output chute valve door, and an upstream valve door. The output chute includes a proximal end and a distal end. The output chute valve door includes a first configuration that obstructs the output chute and a second configuration that does not obstruct the output chute. The upstream valve door includes a first configuration that prevents the output chute valve door from being disposed in its second configuration and a second configuration that permits the output chute valve door to be disposed in its second configuration.

### CROSS-REFERENCE TO RELATED APPLICATIONS

The present application is a continuation of U.S. patent application Ser. No. 18/467,056 filed Sep. 14, 2023, which claims priority and benefit of U.S. Provisional Application No. 63/407,382 filed Sep. 16, 2022, titled DUNNAGE CONVERTER OUTPUT CHUTE SAFETY MECHANISM, the entirety of each of which are incorporated herein by reference.

### FIELD

Embodiments of the present disclosure relate generally to the field of dunnage converters and related safety mechanisms that prevent foreign objects from entering into the dispenser system while providing for output of the packing product.

### BACKGROUND

Dunnage converters are used to create a recyclable paper packaging insert that protects products while minimizing the amount of plastic used in shipping. There are safety risks with the dunnage converters, which turn stock rolls of paper into individual sheets of relatively high volume dunnage. Namely, dunnage converters include parts which are potentially harmful to users should the users come into contact with them, such as gears used to form the dunnage and blades used to cut the sheets of dunnage. Potential injuries can range from relatively minor (e.g., cuts and small abrasions) to severe (e.g., amputated and/or crushed limbs).

Certain safety mechanisms exist to mitigate the risk of harm to users. For example, one safety mechanism currently employed is an output chute with an irregular shape. The irregular shape prevents appendages from being inserted into the output chute and thus prevents appendages from contacting the gears or blades. Most often, irregular shaped output chutes include those of undesirably long length, preventing a user from reaching all the way through the long output chute to touch a blade. This means that the dunnage machine is unable to fit under tables or shelves, and takes up substantial room on the manufacturing line. This can be disruptive to the manufacturing line, and may require design of a proper housing for the dunnage converter.

Another safety mechanism currently employed is an electrically-driven safety valve door, which narrows or seals the opening of the output chute before cutting the dunnage. The electrically-driven safety valve door prevents appendages from contacting the gears or blades. This solution requires costly electrical and mechanical parts. Furthermore, a loss of power could result in a complete failure of this safety mechanism (e.g., the electrically-driven safety valve door being “propped” open when power is lost).

A third safety mechanism currently employed is a mechanical valve door inside the output chute, which blocks any foreign object from entering the output chute in the upstream direction, but allows dunnage product to flow downstream through the output chute. This is accomplished by adding a slot or a shoulder, upstream of the valve door. However, this solution suffers from potential tolerance issues which may allow the valve door to be opened by users while the converter is in use. Historically, simple workarounds such as adding a piece of tape whereby users can open the valve door wide enough to insert an appendage during use has led to injuries. The lack of fail-safes on current versions of this design is undesirable.

Therefore, an output chute safety mechanism that optimizes cost, is not susceptible to malfunction, and can be easily incorporated into the spatial constraints of manufacturing lines is needed.

### SUMMARY

The output chute safety mechanisms disclosed herein improve dunnage converter safety by implementing an upstream valve door and an output chute valve door, which cannot be opened from outside the output chute. Both the upstream valve door and the output chute valve door are mechanically biased in a locked configuration by gravity. Namely, a loss of electrical power has no effect on the functionality of the doors. These mechanisms advantageously provide users with a cost-effective solution that is not susceptible to malfunction and can be incorporated into the spatial constraints of the work station.

In light of the disclosure herein, and without limiting the scope of the invention in any way, in a first aspect of the present disclosure, which may be combined with any other aspect listed herein unless specified otherwise, an output chute safety mechanism includes an output chute, an output chute valve door, and an upstream valve door. The output chute includes a proximal end and a distal end. The output chute valve door includes a first configuration that obstructs the output chute and a second configuration that does not obstruct the output chute. The upstream valve door includes a first configuration that prevents the output chute valve door from being disposed in its second configuration and a second configuration that permits the output chute valve door to be disposed in its second configuration.

In a second aspect of the present disclosure, which may be combined with any other aspect listed herein unless specified otherwise, the output chute valve door is rotationally biased to being disposed in its first configuration. The upstream valve door is rotationally biased to being disposed in its first configuration.

In a third aspect of the present disclosure, which may be combined with any other aspect listed herein unless specified otherwise, the upstream valve door includes a blocking mechanism. The blocking mechanism is configured to prevent the output chute valve door from being disposed in its second configuration when the upstream valve door is disposed in its first configuration.

In a fourth aspect of the present disclosure, which may be combined with any other aspect listed herein unless specified otherwise, the upstream valve door includes a first end and second end. The upstream valve door rotates from the first configuration to the second configuration when a force is applied at the second end.

In a fifth aspect of the present disclosure, which may be combined with any other aspect listed herein unless specified otherwise, the upstream valve door is configured to rotate to the first configuration when a force is not being applied at the second end.

In a sixth aspect of the present disclosure, which may be combined with any other aspect listed herein unless specified otherwise, the output chute valve door is configured to prevent access to the output chute when the output chute valve door is disposed in the first configuration.

In a seventh aspect of the present disclosure, which may be combined with any other aspect listed herein unless specified otherwise, the first configuration of the output chute valve door is a closed position of the output chute valve door, and the first configuration of the upstream valve door is a closed position of the upstream valve door.

In an eighth aspect of the present disclosure, which may be combined with any other aspect listed herein unless specified otherwise, dunnage material is dispensed from the distal end of the output chute.

In a ninth aspect of the present disclosure, which may be combined with any other aspect listed herein unless specified otherwise, the output chute is configured to be coupled to a dispenser.

In a tenth aspect of the present disclosure, which may be combined with any other aspect listed herein unless specified otherwise, the output chute is configured to be angled relative to the ground.

In an eleventh aspect of the present disclosure, which may be combined with any other aspect listed herein unless specified otherwise, an output chute safety mechanism includes an output chute, an upstream valve door that remains in a closed configuration unless dunnage is being dispensed through the output chute, and an output chute valve door that remains in a closed configuration unless the upstream valve door is in an open configuration.

In a twelfth aspect of the present disclosure, which may be combined with any other aspect listed herein unless specified otherwise, the output chute is configured to be coupled to a dispenser.

In a thirteenth aspect of the present disclosure, which may be combined with any other aspect listed herein unless specified otherwise, the output chute valve door cannot be rotated to the open configuration by reaching into the output chute at a distal end of the output chute.

In a fourteenth aspect of the present disclosure, which may be combined with any other aspect listed herein unless specified otherwise, the output chute valve door is biased to the closed configuration.

In a fifteenth aspect of the present disclosure, which may be combined with any other aspect listed herein unless specified otherwise, the upstream valve door is biased to the closed configuration.

In a sixteenth aspect of the present disclosure, which may be combined with any other aspect listed herein unless specified otherwise, each of the output chute valve door and the upstream valve door are hingedly coupled to a top side of the output chute.

In a seventeenth aspect of the present disclosure, which may be combined with any other aspect listed herein unless specified otherwise, dunnage material is dispensed through the output chute from a proximal end to a distal end.

In an eighteenth aspect of the present disclosure, which may be combined with any other aspect listed herein unless specified otherwise, dunnage material causes the upstream valve door to pivot from the closed configuration to the open configuration.

In a nineteenth aspect of the present disclosure, which may be combined with any other aspect listed herein unless specified otherwise, a method for safely dispensing dunnage includes receiving dunnage at a proximal end of an output chute and pivoting open an upstream valve door. The method includes disengaging a blocking mechanism on the upstream valve door and pivoting open an output chute valve door. The method includes dispensing dunnage from a distal end of the output chute.

In a twentieth aspect of the present disclosure, which may be combined with any other aspect listed herein unless specified otherwise, the method further includes pivoting closed the output chute valve door, re-engaging the blocking mechanism on the upstream valve door, and pivoting closed the upstream valve door.

Additional features and advantages of the disclosed devices, systems, and methods are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein. Moreover, it should be noted that the language used in the specification has been selected for readability and instructional purposes, and not to limit the scope of the inventive subject matter.

### BRIEF DESCRIPTION OF THE FIGURES

Understanding that figures depict only typical embodiments of the invention and are not to be considered to be limiting the scope of the present disclosure, the present disclosure is described and explained with additional specificity and detail through the use of the accompanying figures. The figures are listed below.

FIG. 1 illustrates a side view of a complete dunnage converter according to an example embodiment of the present disclosure.

FIG. 2 illustrates a perspective section view of a portion of a dunnage converter according to an example embodiment of the present disclosure.

FIGS. 3A to 3C illustrate cross-section views of an output chute of a dunnage converter according to an example embodiment of the present disclosure.

FIG. 4 illustrates a side view of an output chute of a dunnage converter according to an example embodiment of the present disclosure.

FIGS. 5A to 5C illustrate perspective views of an output chute of a dunnage converter according to an example embodiment of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

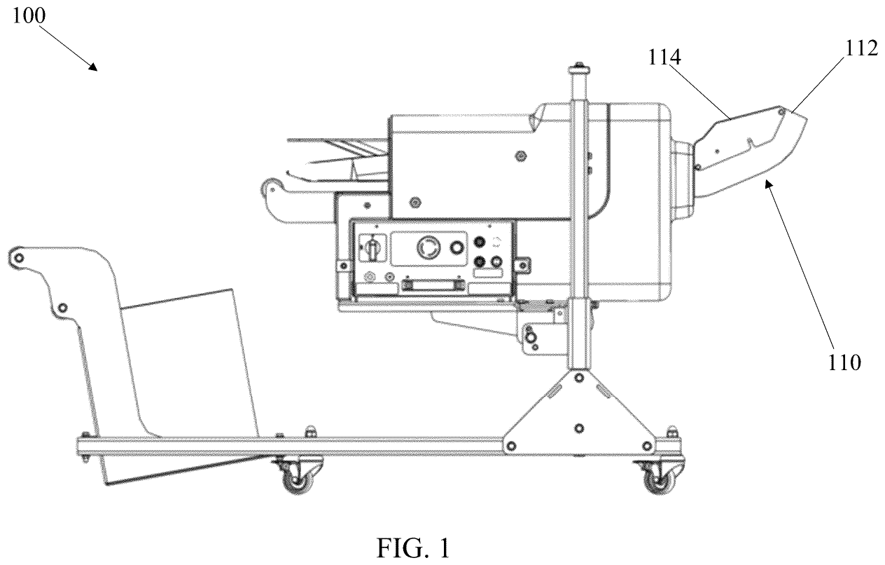

With reference to the Figures, FIG. 1 illustrates a side view of a dunnage converter according to an embodiment, which includes a dispenser 100 having an output chute 110. Namely, dunnage is formed within dispenser 100 and ejected from output chute 110. Once ejected, users can use the dunnage for cushioning during packing processes. Output chute 110 includes an output chute guide tunnel 112 and an output chute guard 114.

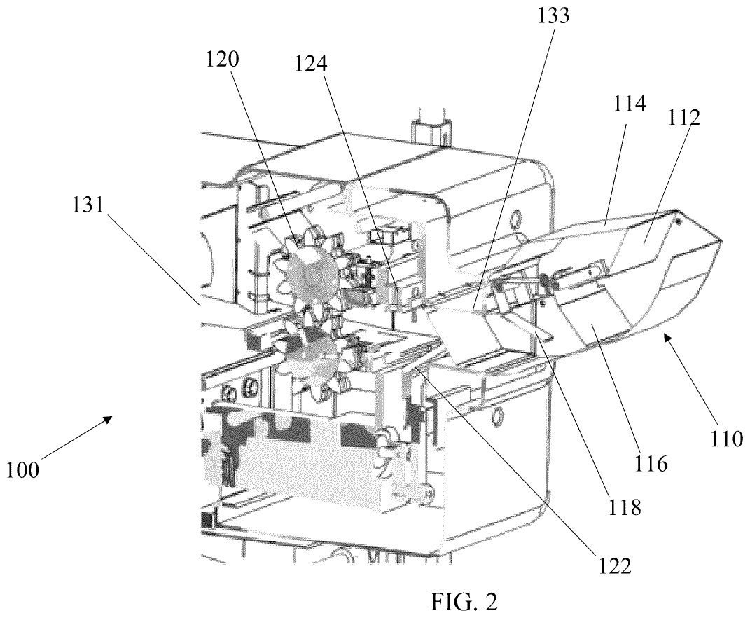

FIG. 2 illustrates a perspective section view of a portion of dispenser 100. Dispenser 100 includes an input side 131 and an output side 133. For example, flat paper is received by dispenser 100 at the input side 131. Dispenser 100 converts this flat paper into crumpled dunnage via a plurality of rotatable gears 120. The crumpled dunnage is dispensed at the output side 133. While dispensing, dispenser 100 cuts the dunnage via blades 122, 124 into rectangular strips. These rectangular strips of crumpled dunnage are dispensed at the output side 133.

Output chute 110 is coupled to dispenser 100 at the output side 133 of the dispenser 100. The output chute 110, including the output chute guide tunnel 112 and the output chute guard 114, are constructed of one or more of metal, plastic, or similarly durable material such that the shape of the output chute 110 is retained when a load is placed on it from the operation of the dunnage converter.

The output chute 110 includes an output chute valve door 116 and an upstream valve door 118, both of which are rotationally attached to the output chute 110 within the output chute guide tunnel 112. For example, each of output chute valve door 116 and upstream valve door 118 are hinged and pivotally coupled to a top side of the output chute guide tunnel 112.

During the dispensing process, dunnage travels from the input side 131 of the dispenser 100 to the output side 133 as the dunnage is formed. Dunnage then travels through the output chute guide tunnel 112 starting at the proximal end of the output chute guide tunnel 112, contacting the upstream valve door 118; this contact causes the upstream valve door 118 to rotate upwards, about its hinge, as the upstream valve door 118 is pushed by the dunnage towards the distal end of the output chute guide tunnel 112. Dunnage then contacts the output chute valve door 116; this contact causes the output chute valve door 116 to rotate upwards, about its hinge, as the output chute valve door 116 is pushed by the dunnage towards the distal end of the output chute guide tunnel 112. It should be appreciated that each of the upstream valve door 118 and the output chute valve door 116 are constructed of one or more of metal, plastic, or similarly durable to withstand the stresses involved in the operation of the dunnage converter.

As discussed in greater detail herein, each of the output chute valve door 116 and the upstream valve door 118 are mechanically configured to be biased in “closed” configurations. Namely, by being hinged and pivotally coupled to the top side of the output chute guide tunnel 112, gravity causes each of the output chute valve door 116 and the upstream valve door 118 to be disposed in closed configurations. Only responsive to pressure from dunnage dispensed from dispenser 100 (as noted above) will each of the output chute valve door 116 and the upstream valve door 118 transition to open configurations. Furthermore, as discussed in greater detail herein, the output chute valve door 116 and the upstream valve door 118 are mechanically linked with one another; namely, the output chute valve door 116 cannot open or transition to an opened configuration until the upstream valve door 118 is first transitioned to an open configuration.

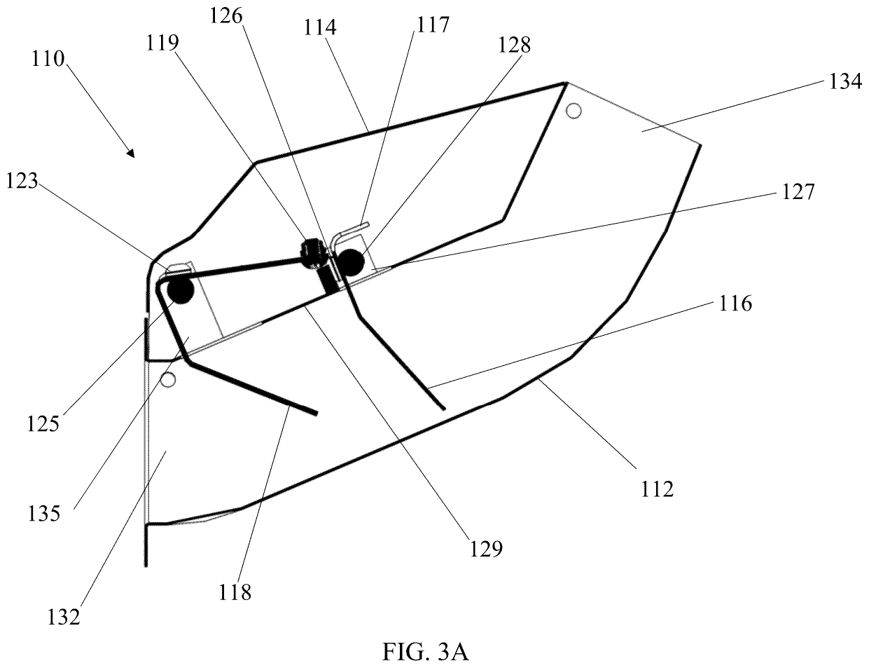

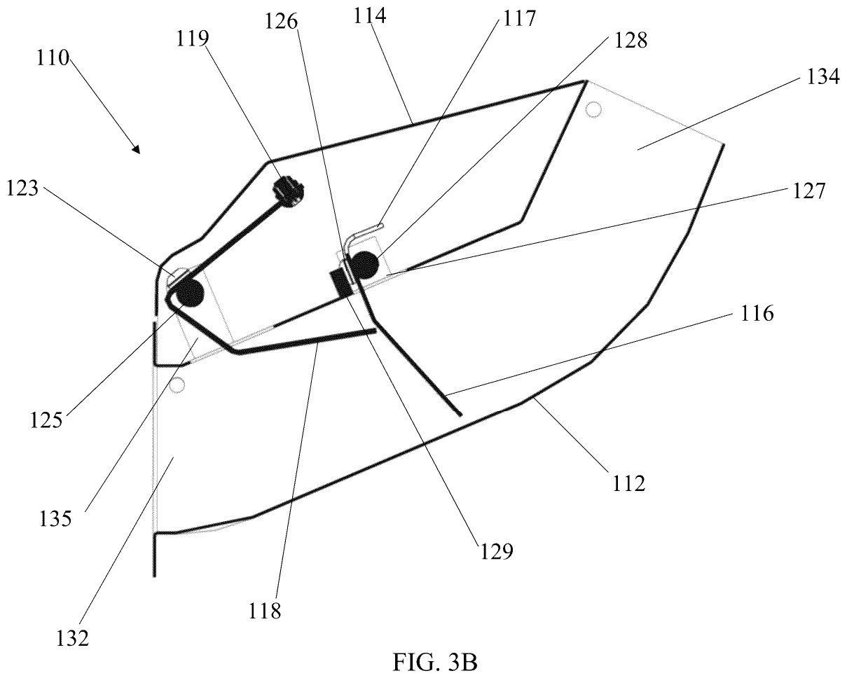

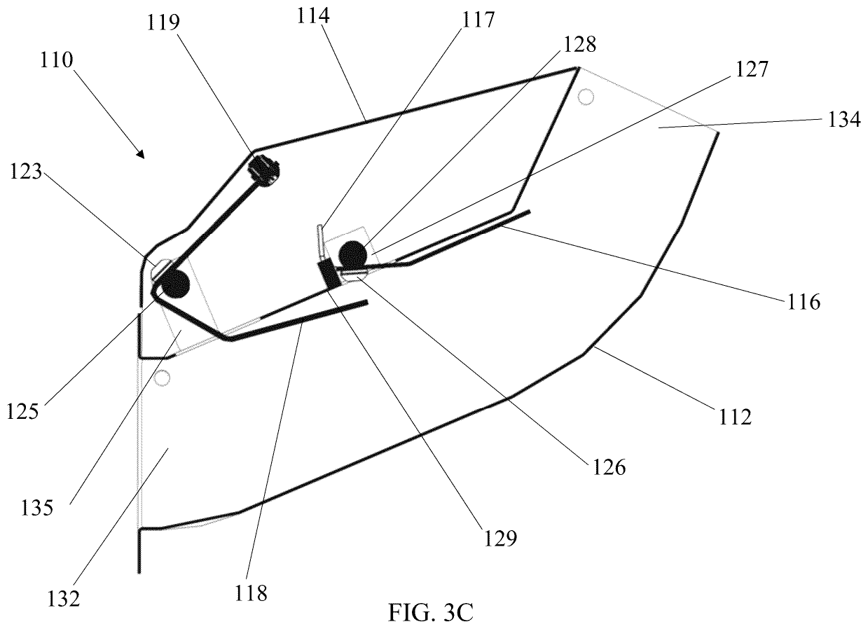

FIGS. 3A to 3C illustrate a cross-section of an output chute 110. Turning to FIG. 3A, FIG. 3A shows a cross-section of output chute 110 in closed configuration. As noted previously, output chute 110 includes output chute guide tunnel 112 and output chute guard 114, which collectively house the output chute valve door 116 and the upstream valve door 118.

The upstream valve door 118 is configured to pivot around an upstream valve door axis 125. Upstream valve door axis 125 is connected to the output chute guide tunnel 112 by a valve door axis mount 135. Valve door axis mount 135 is preferably made of a metal, plastic, or other durable material that can withstand the rotation of the upstream valve door axis 125 and upstream valve door 118, as well as the heat from any friction caused by the rotation. The upstream valve door 118 is fixedly attached to the upstream valve door axis 125 by an upstream valve door axis bracket 123. The upstream valve door axis bracket 123 may be made of a durably flexible material that protects the upstream valve door 118 and the output chute guard 114 from wearing down due to the repeated swinging of the upstream valve door 118.

Similarly, the output chute valve door 116 is configured to pivot around an output chute valve door axis 128. Output chute valve door axis 128 is connected to the output chute guide tunnel 112 by an output chute valve door axis mount 127. Output chute valve door axis mount 127 is preferably made of a metal, plastic, or other durable material that can withstand the rotation of the output chute valve door axis 128 and output chute valve door 116, as well as the heat from any friction caused by the rotation. The output chute valve door 116 is fixedly attached to the output chute valve door axis 128 by an output chute valve door axis bracket 126. The output chute valve door axis bracket 126 may be made of a durably flexible material that protects the output chute valve door 116 and the output chute guard 114 from wearing down due to the repeated swinging of the output chute valve door 116.

As noted previously, the upstream valve door 118 has an open configuration and a closed configuration. More specifically, an output chute blocking mechanism 119 is coupled to the upstream valve door 118. When the dunnage converter is not in operation, the weight of the output chute blocking mechanism 119 and its physical positioning relative to upstream valve door axis 125 biases the upstream valve door 118 in the closed configuration (as depicted in FIG. 3A). When the upstream valve door 118 is in the closed configuration, the output chute blocking mechanism 119 rests on a blocking mount 129 that is coupled to the output chute guide tunnel 112. Output chute valve door 116 also has an open configuration and a closed configuration. The output chute valve door 116 includes output chute valve door stopper 117. For example, output chute valve door stopper 117 is angled bracket disposed away from output chute valve door axis 128. When the upstream valve door 118 is disposed in the closed configuration, the output chute blocking mechanism 119 blocks the output chute valve door stopper 117 from freely rotating; this prevents the output chute valve door 116 from pivoting into the open configuration. Furthermore, the geometry of output chute valve door stopper 117 is configured to guide both upstream valve door 118 and output chute blocking mechanism 119 as upstream valve door 118 is closing; for example, as the upstream valve door 118 closes, prior to output chute valve door 116's closure, the geometry of output chute valve door stopper 117 guides upstream valve door 118 and output chute blocking mechanism 119 to correctly close, so that these components are not inadvertently blocked by a portion of output chute valve door 116.

Turning to FIG. 3B, FIG. 3B shows the output chute mid-operation. When the dunnage converter (not pictured) is in use, dunnage moves from the proximal end 132 of output chute guide tunnel 112 to the distal end 134 of output chute guide tunnel 112. First, dunnage travels into the output chute 110 and contacts the upstream valve door 118. The force from the dunnage causes the upstream valve door 118 to pivot about the upstream valve door axis 125, thereby shifting the upstream valve door 118 to an open configuration. As the upstream valve door 118 pivots about upstream valve door axis 125, the chute blocking mechanism 119 similarly pivots such that it no longer rests on blocking mount 129; in other words, the chute blocking mechanism 119 moves such that it no longer blocks the output chute valve door stopper 117 from freely rotating, thereby effectively “unlocking” the output chute valve door 116. The output chute valve door 116 remains unlocked so long as dunnage passing through the output chute 110 places force on the upstream valve door 118.

Continuing on, FIG. 3C shows the output chute in an open configuration. Namely, as dunnage continues moving from the proximal end 132 of output chute guide tunnel 112 to the distal end 134 of output chute guide tunnel 112, after it forces the upstream valve door 118 open (described in FIG. 3B above), the dunnage contacts the output chute valve door 116. The force from the dunnage causes the output chute valve door 116 to pivot about the output chute valve door axis 128, thereby shifting the output chute valve door 116 to an open configuration. Output chute valve door 116 is capable of pivoting to an open configuration solely because upstream valve door 118 is already in an open configuration; as output chute valve door 116 pivots about output chute valve door axis 128, output chute valve door stopper 117 is not blocked, such that the entire output chute valve door 116 may freely rotate.

While the upstream valve door 118 and the output chute valve door 116 are in the open configuration, dunnage is continually being output from output chute guide tunnel 112; this continual output prevents users from reaching toward the proximal end 132 of output chute guide tunnel 112 side through the distal end 134 of output chute guide tunnel 112.

Once users remove dunnage from the output chute 110, such that dunnage is no longer being produced, the upstream valve door 118 and the output chute valve door 116 pivot into closed configurations. More specifically, when there is no lateral directional force placed on the upstream valve door 118 by dunnage, the output chute blocking mechanism 119 acts as a counterweight that rotates the upstream valve door 118 about upstream valve door axis 125 into the closed configuration. Similarly, when there is no lateral directional force placed on the output chute valve door 116 by dunnage, the output chute valve door 116 rotates about output chute valve door axis 128 into a closed configuration. As the output chute valve door 116 rotates into a closed configuration, the output chute blocking mechanism 119 rests on blocking mount 129, such that the output chute blocking mechanism 119 blocks the output chute valve door stopper 117 from freely rotating.

In short, users are unable to bypass the upstream valve door 118 and the output chute valve door 116 after removing dunnage, because both doors 118, 116 close automatically and the output chute valve door 116 lock automatically. The only way to unlock output chute valve door 116 is by first unlocking upstream valve door 118; the only way to unlock upstream valve door 118 is via a lateral directional force within the output chute guide tunnel 112 in the direction of the distal end 134 (i.e., caused by dunnage being dispensed through output chute guide tunnel 112).

It should be appreciated that the output chute valve door stopper 117 is dimensioned so as to allow the output chute valve door stopper 117 to slide along the output chute blocking mechanism 119 when moving into the closed configuration, while also preventing the output chute valve door 116 from rotating open once in a closed configuration. Additionally, referring back to FIG. 3A, when no dunnage product is moving through the output chute 110, the upstream valve door 118 and the output chute valve door 116 are in their respective closed and locked configurations and are biased into these configurations via gravity.

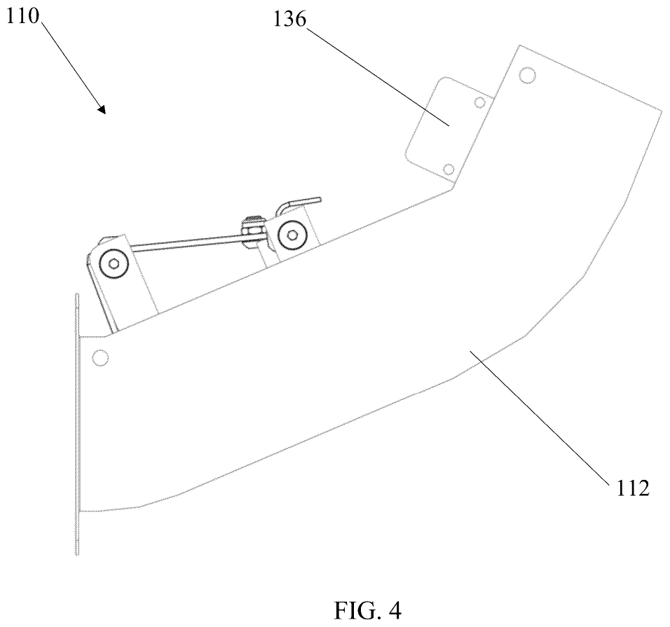

FIG. 4 shows a side view of output chute 110, without a safety housing over the output chute guide tunnel 112. Rather, the output chute guide tunnel 112 includes an output chute guard attachment flange 136. In an embodiment, output chute guard attachment flange 136 provides a mounting point for attaching a safety housing (not pictured) to the output chute 110. Such a configuration allows for a safety housing to be removable from the output chute 110, which in turn allows for maintenance to be performed on the safety components of the output chute 110 in case of damage or wear on the components. The output chute guard attachment flange 136 is made of metal, plastic, or other durable material such that a nut and bolt can be threaded through it to removably couple a safety housing. Other coupling mechanisms between the output chute guard attachment flange 136 and a safety housing are contemplated as well. In another embodiment, output chute guard attachment flange 136 provides a mounting point for a sensor (e.g., a sensor to detect dunnage within output chute guide tunnel 112). For example, when dunnage is removed, the sensor detects that output chute guide tunnel 112 is empty; sensor may advantageously communicate this “empty” condition to a controller, such that the controller may produce a new strip of dunnage via dispenser 100 (e.g., “take out” mode).

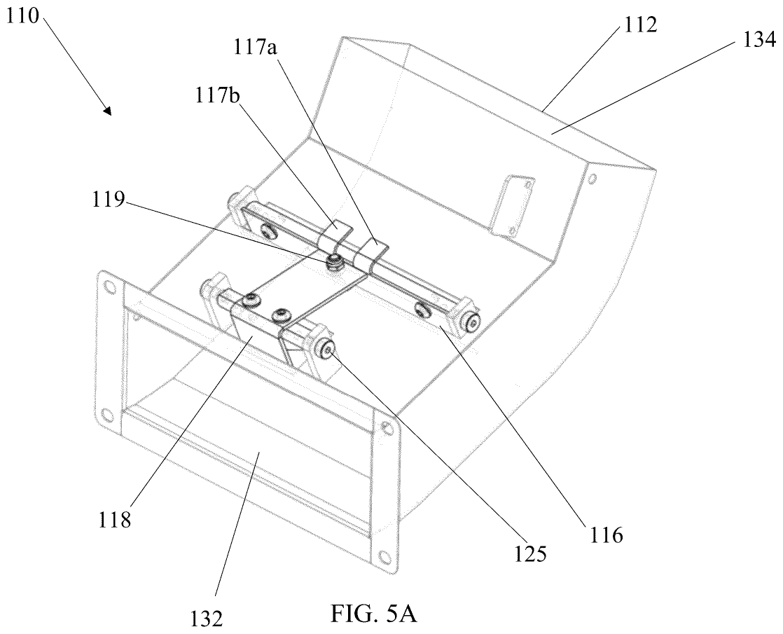

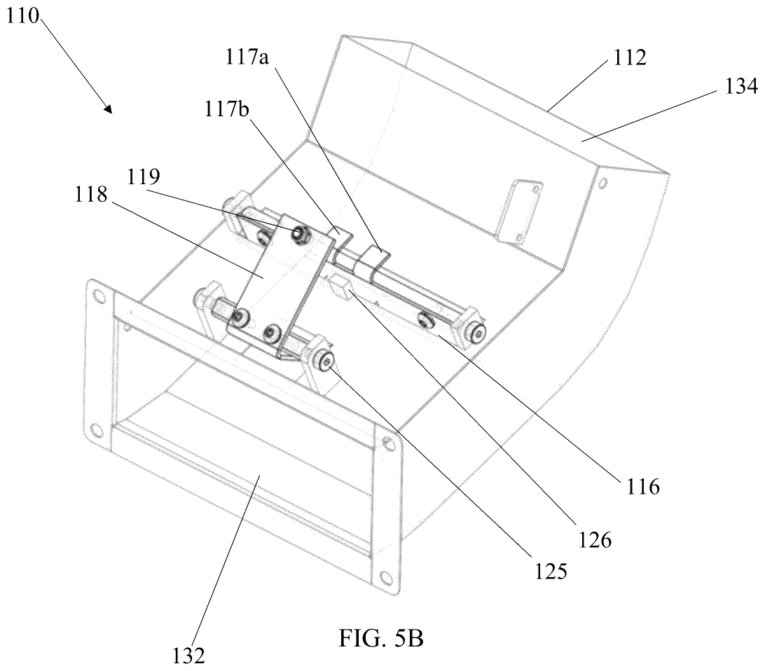

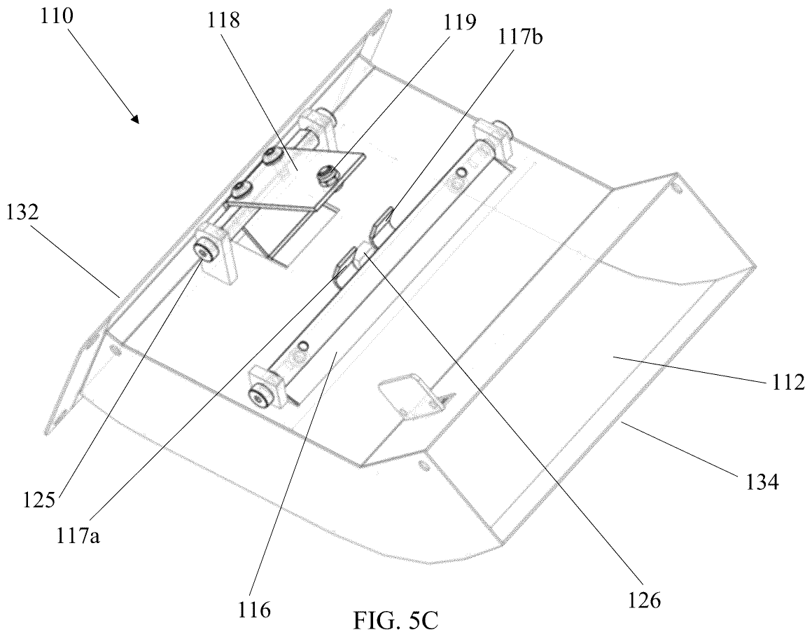

FIGS. 5A to 5C show perspective views of output chute 110, providing additional views and detail. In FIG. 5A, the output chute 110 includes output chute guide tunnel 112 having a proximal end 132 and a distal end 134. Output chute 110 includes upstream valve door 118, disposed in a closed configuration that locks the output chute valve door 116 in a closed configuration. More specifically, the upstream valve door 118 includes output chute blocking mechanism 119. The output chute blocking mechanism 119 is coupled to the upstream valve door 118. A counterweight portion on the output chute blocking mechanism 119 is sufficiently weighted to orient the upstream valve door 118 in a closed configuration when dunnage converter is not operation. The counterweight portion on the output chute blocking mechanism 119 can, for example, include bolts, nuts, or similarly constructed hardware that can simply and inexpensively couple to the output chute blocking mechanism 119 to add sufficient counterweight for gravity biasing.

As noted previously, the edge of the output chute blocking mechanism 119 is disposed adjacent to output chute valve door stopper 117, such that the output chute blocking mechanism 119 blocks the output chute valve door stopper 117 from freely rotating. As illustrated in FIGS. 5A to 5C, output chute valve door stopper 117 is a two-part stopper, including output chute stoppers 117a, 117b of the output chute valve door 116. As described previously above, the output chute blocking mechanism 119 edge is geometrically shaped such that it interlocks with the output chute stoppers 117a, 117b when the output chute valve door 116 is in a closed configuration; likewise, output chute blocking mechanism 119 is geometrically shaped to permit the output chute valve door 116 to return to the closed configuration, from the open configuration, without interlocking with the output chute stoppers 117a, 117b.

FIG. 5B shows the output chute 110, mid-operation. When the dunnage converter (not pictured) is in use, dunnage moves from the proximal end 132 of the output chute guide tunnel 112 toward the distal end 134 of the output chute guide tunnel 112.

As dunnage exerts a force on the upstream valve door 118, the upstream valve door 118 pivots about the upstream valve door axis 125, thereby shifting the upstream valve door 118 to an open configuration. When the upstream valve door 118 pivots, so too does the output chute blocking mechanism 119. The output chute blocking mechanism 119 edge moves, such that it no longer interlocks with the output chute valve door stoppers 117a, 117b. When the output chute valve door stoppers 117a, 117b no longer interlock, the output chute blocking mechanism 119 edge does not exert a normal force on the output chute valve door stoppers 117a, 117b, such that the output chute valve door 116 may pivot freely toward the top of the output chute guide tunnel 112. The output chute blocking mechanism 119 will not interlock with the output chute valve door stoppers 117a, 117b so long as dunnage is being produced and exerts a force on the upstream valve door 118.

Continuing on, FIG. 5C shows the output chute 110 in an open configuration. The output chute valve door 116 may pivot when a force is applied to it in direction of the distal end 134. In an embodiment, this force is applied by the internal edge of the upstream valve door 118. For example, as upstream valve door 118 pivots into the open configuration, it contacts output chute valve door 116 to, likewise, pivot into the open configuration. In alternative embodiments, this force may be applied by the dunnage moving from the proximal end 132 of the output chute guide tunnel 112 toward the distal end 134 of the output chute guide tunnel 112.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An output chute safety mechanism comprising:
an output chute including a proximal end and a distal end;
an output chute valve door having a door stopper, wherein the output chute valve door is configured to move between a first configuration that obstructs the output chute and a second configuration that does not obstruct the output chute; and
an upstream valve door having a blocking mechanism, wherein the upstream valve door is configured to move between a first configuration that prevents the output chute valve door from being disposed in its second configuration, and the upstream valve door having a second configuration that permits the output chute valve door to be disposed in its second configuration;
wherein when the upstream valve door is in at least the first configuration, the blocking mechanism of the upstream valve door blocks the door stopper of the output chute valve door and prevents the output chute valve door from moving to the second configuration.

2. The output chute safety mechanism of claim 1, wherein the output chute valve door is rotationally biased to being disposed in its first configuration; and
wherein the upstream valve door is rotationally biased to being disposed in its first configuration.

3. The output chute safety mechanism of claim 1, wherein the blocking mechanism comprises a counterweight portion to bias the upstream valve door in the first configuration, and wherein the door stopper is an angled bracket disposed away from an output chute valve door axis that guides the blocking mechanism as the upstream valve door moves to the first configuration.

4. The output chute safety mechanism of claim 1, wherein the upstream valve door includes a first end and second end; and
wherein the upstream valve door rotates from the first configuration to the second configuration when a force is applied at the second end.

5. The output chute safety mechanism of claim 4, wherein the upstream valve door is configured to rotate to the first configuration when a force is not being applied at the second end.

6. The output chute safety mechanism of claim 1, wherein the output chute valve door is configured to prevent access to the output chute when the output chute valve door is disposed in the first configuration.

7. The output chute safety mechanism of claim 1, wherein the first configuration of the output chute valve door is a closed position of the output chute valve door, and wherein the first configuration of the upstream valve door is a closed position of the upstream valve door.

8. The output chute safety mechanism of claim 1, wherein dunnage material is dispensed from the distal end of the output chute.

9. The output chute safety mechanism of claim 1, wherein the output chute is configured to be coupled to a dispenser.

10. The output chute safety mechanism of claim 1, wherein the output chute is configured to be angled relative to the ground.

11. An output chute safety mechanism comprising:
an output chute;
an upstream valve door having a blocking mechanism, wherein the upstream valve door remains in a closed configuration unless dunnage material is being dispensed through the output chute; and
an output chute valve door that remains in a closed configuration unless the upstream valve door is in an open configuration;
wherein the blocking mechanism of the upstream valve door engages with a portion of the output chute valve door when the upstream valve door is in at least its closed configuration.

12. The output chute safety mechanism of claim 11, wherein the output chute is configured to be coupled to a dispenser.

13. The output chute safety mechanism of claim 11, wherein the output chute valve door cannot be rotated to the open configuration by reaching into the output chute at a distal end of the output chute.

14. The output chute safety mechanism of claim 11, wherein the output chute valve door is biased to the closed configuration.

15. The output chute safety mechanism of claim 11, wherein the upstream valve door is biased to the closed configuration.

16. The output chute safety mechanism of claim 11, wherein each of the output chute valve door and the upstream valve door are hingedly coupled to a top side of the output chute.

17. The output chute safety mechanism of claim 11, wherein dunnage material is dispensed through the output chute from a proximal end to a distal end.

18. The output chute safety mechanism of claim 17, wherein the dunnage material causes the upstream valve door to pivot from the closed configuration to the open configuration.

19. A method for safely dispensing dunnage comprising:
receiving dunnage material at a proximal end of an output chute;
pivoting open an upstream valve door;
disengaging a blocking mechanism on the upstream valve door that was engaged with a portion of an output chute valve door when opening the upstream valve door;
pivoting open the output chute valve door when the blocking mechanism is disengaged; and
dispensing the dunnage material from a distal end of the output chute.

20. The method of claim 19, further comprising:
pivoting closed the output chute valve door; and
re-engaging the blocking mechanism on the upstream valve door with the portion of the output chute valve door when pivoting closed the upstream valve door.
